(19) United States
(12) Patent Application Publication
(10) Pub. No.: US 2006/0057434 A1
(43) Pub. Date: Mar. 16, 2006

(54) Fuel cell power generation system

(75) Inventors: Yasuhiko Ogushi, Tokyo (JP); Yuto Takagi, Tokyo (JP)

Correspondence Address: FOLEY AND LARDNER LLP;SUITE 500, 3000 K STREET NW, WASHINGTON, DC, 20007, US

(73) Assignee: EBARA Ballard Corporation

(21) Appl. No.: 10/938,879

(22) Filed: Sep. 13, 2004

(51) Int. Cl. H01M 8/00; H01M 8/04

(52) U.S. Cl. 429/12; 429/26

(57) ABSTRACT

A fuel cell power generation system is provided in which the dew point of a reformate supplied from a fuel processing system to the fuel cell stack is controlled appropriately with a simple configuration. The system comprises: a cell stack 4 for generating electricity using a reformate containing hydrogen as a main ingredient thereof and a water content; a fuel processing system 1 for reforming a hydrocarbon-based fuel into the reformate; a first heat exchanger 6 for cooling, with the use of external coolant, a coolant which cools the cell stack 4; and a second heat exchanger 2 for exchanging heat between the coolant cooled with the first heat exchanger 6 and the fuel gas supplied from the fuel processing system 1 to the cell stack 4, wherein the coolant after exchanging heat with the fuel gas in the second heat exchanger 2 is supplied to the cell stack 4.

### BACKGROUND OF THE INVENTION

1. Technical Field

This invention relates to a fuel cell power generation system for generating electricity by supplying a reformate produced in a fuel processing system to a fuel cell stack, and is more particularly concerned with dew point control of the reformate.

2. Related Art

A fuel cell power generation system generates electricity with a fuel cell stack by supplying a reformate produced in a fuel processing system to the fuel cell stack. In the fuel processing system, hydrogen gas is obtained by causing water to react with a hydrocarbon-based compound as a fuel. In the fuel cell stack, hydrogen gas contained-in the reformate is caused to react with oxygen to obtain water, electric power and heat. Here, it is a requirement for generation of electricity with the fuel cell stack that membranes forming the fuel cell stack are wet. Therefore, to prevent the fuel cell stack from getting dry, it is necessary that the reformate to be supplied to the fuel cell stack contains a certain content of water.

FIG. 5 shows a conventional block diagram in which water vapor is added to a reformate. A fuel processing system (FPS) 1 reforms a city gas as a fuel gas into the reformate. Then a moistening water supplier 2A adds water to the reformate, which is in turn supplied to a fuel cell stack (FCS) 4. Because the temperature in the fuel cell stack 4 must be held constant within a range of 50 to 60° C., for example, a pump 7 is used in the piping constituting a fuel cell cooling system 5A to flow a coolant therethrough. The fuel cell stack 4, while it produces heat by power generation reaction, is cooled with the fuel cell cooling system 5A. A fuel cell cooling system heat exchanger 6 cools the coolant flowing through the fuel cell cooling system 5A. The moistening water supplier 2A injects the moistening water controlled to an appropriate temperature into the outlet of the fuel processing system 1 to make the water content in the reformate a certain value.

FIG. 6 shows a conventional block diagram for cooling a reformate to be supplied to a fuel cell stack. In a fuel processing system 1, a city gas as a fuel gas is reformed into a reformate. The reformate is cooled in a fuel supply system heat exchanger 2B and supplied to a fuel cell stack 4. The fuel cell stack 4 is cooled to be at a constant temperature by a fuel cell cooling system 5A and a fuel cell cooling system heat exchanger 6. A pump 7B is used in a fuel supply system cooling system 5B to flow coolant through the fuel supply system heat exchanger 2B to cool the reformate to be supplied to the fuel cell stack 4 so as to control the dew point of the reformate.

However, if the dew-point temperature of the reformate supplied to the fuel cell stack 4 is too high, water content in the reformate condenses within the fuel cell stack 4. This is a factor of impeding stability in generation of electricity. Therefore, in the water content control by injecting moistening water as shown in FIG. 5, the dew point of the reformate is controlled by adjusting the temperature of the moistening water. Then, the water content control by injecting moistening water must be sophisticated, which gives rise to a problem that the fuel cell power generation system becomes complicated.

When two cooling systems, the fuel cell cooling system 5A and the fuel supply system cooling system 5B as shown in FIG. 6, are provided, the dew point of the reformate is controlled with the fuel supply system cooling system 5B in practice. However, because a pump must be provided in each cooling system, a problem arises that the cooling system for the fuel cell power generation system becomes complicated. Besides, because the fuel cell cooling system 5A and the fuel supply system cooling system 5B are independent of each other, when the fuel cell cooling system 5A fluctuates, the fuel supply system cooling system 5B is required to follow the fluctuation, which gives rise to another problem that the control becomes complicated.

This invention is to solve the above problems and the object is therefore to provide a fuel cell power generation system in which the dew point of the reformate supplied from the fuel processing system to the fuel cell stack is controlled appropriately with a simple configuration.

### SUMMARY OF THE INVENTION

In order to achieve the above object, a fuel cell power generation system according to the invention, as shown for example in FIG. 1, comprises: a cell stack 4 for generating electricity using a reformate containing hydrogen as a main ingredient thereof and a water content; a fuel processing system 1 for reforming a hydrocarbon-based fuel into the reformate; a first heat exchanger 6 for cooling, with a use of an external coolant, a coolant which cools the cell stack 4; and a second heat exchanger 2 for exchanging heat between the coolant cooled with the first heat exchanger 6 and the reformate supplied from the fuel processing system 1 to the cell stack 4, wherein the coolant after exchanging heat with the reformate in the second heat exchanger 2 is supplied to the cell stack 4.

In the system having a configuration as described, because the reformate is cooled in the second heat exchanger 2, the dew point of the reformate comes to an optimum value and the water content can be prevented from condensing within the cell stack 4. Besides, because the first heat exchanger 6 and the second heat exchanger 2 use the same coolant, a single piping for the coolant suffices for the purpose, and the configuration becomes simple. Here, the fuel cell used in the cell stack 4 is typically one using solid polymer membranes as an electrolyte. The coolant is typically water.

Preferably, if the second heat exchanger 2 is configured to make the dew-point temperature of the reformate after exchanging heat not higher than the temperature of the coolant after exchanging heat, the dew-point temperature of the reformate after exchanging heat becomes lower than the internal temperature of the cell stack 4 cooled with the coolant, so that condensation of the water content within the cell stack 4 is avoided.

The basic Japanese Patent Application No. 2002-181036 filed on Jun. 21, 2002 is hereby incorporated in its entirety by reference into the present application.

The present invention will become more fully understood from the detailed description given hereinbelow. The other applicable fields will become apparent with reference to the detailed description given hereinbelow. However, the detailed description and the specific embodiment are illustrated of desired embodiments of the present invention and are described only for the purpose of explanation. Various changes and modifications will be apparent to-those ordinary skilled in the art on the basis of the detailed description.

The applicant has no intention to give to public any disclosed embodiments. Among the disclosed changes and modifications, those which may not literally fall within the scope of the present claims constitute, therefore, a part of the present invention in the sense of doctrine of equivalents.

### BRIEF DESCRIPTION OF THE DRAWINGS

FIG. 1 is a block diagram, illustrating a fuel cell power generation system of a first embodiment according to the invention.

FIG. 2 is a basic structural drawing, illustrating a configuration of a fuel cell stack 4.

FIG. 3 is a graph, showing the dew-point temperature of a reformate and the coolant temperature at a fuel cell inlet as they change with the lapse of operation time.

FIG. 4 is a block diagram, illustrating a fuel cell power generation system of a second embodiment according to the invention.

FIG. 5 is a conventional block diagram in which hydrogen is added to a reformate.

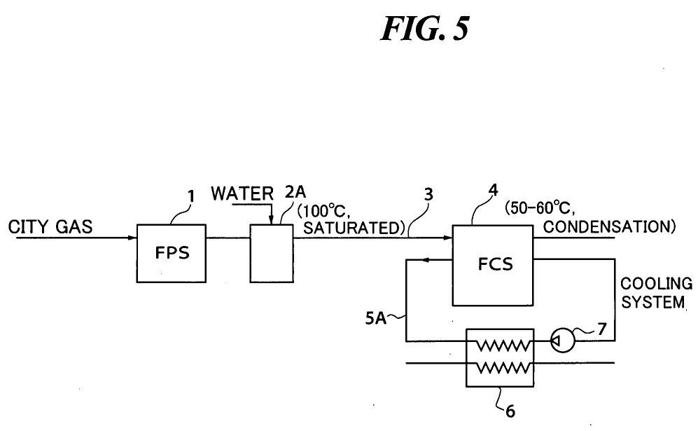

FIG. 6 is a conventional block diagram for cooling a reformate to be supplied to a fuel cell stack.

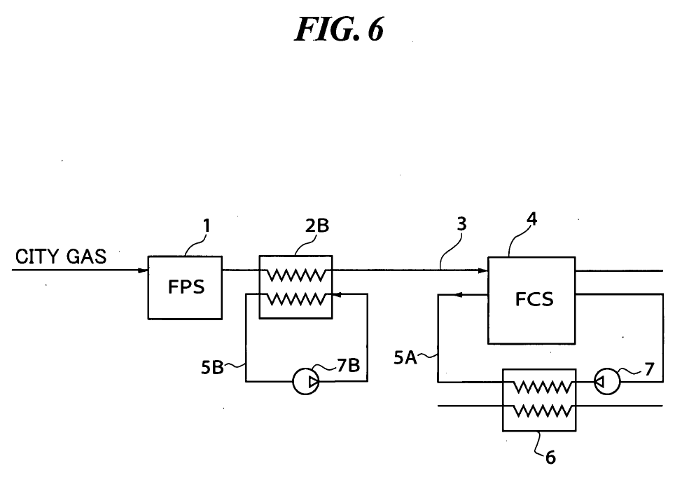

### DETAILED DESCRIPTION OF PREFERRED EMBODIMENTS

Embodiments of the invention are described hereinafter with reference to the appended drawings. In the drawings, the same or corresponding members are provided with the same reference numerals or similar symbols, and the same explanation is not repeated.

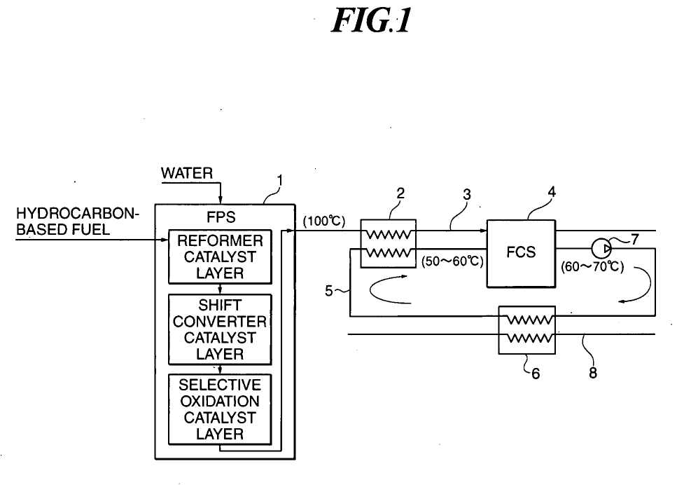

FIG. 1 is a block diagram, illustrating a fuel cell power generation system of a first embodiment according to the invention. In the figure, a fuel processing system 1 is to reform a hydrocarbon-based fuel into a reformate (reformed gas) and is constituted for example with a reformer catalyst layer, a shift converter catalyst layer, and a selective oxidation catalyst layer. The fuel processing system 1 produces a reformate containing saturated water vapor by a reaction represented by an equation shown below. That is to say, in the reformer catalyst layer, mainly a water vapor reformer reaction of the hydrocarbon-based fuel occurs. For example, when the hydrocarbon-based fuel is methane, the water vapor reformer reaction occurs according to the following equation:
CH₄+H₂O→CO+3H₂ (1)

The reformer catalyst for use in the reformer catalyst layer may be any one as long as it accelerates the reformer reaction, and is, for example, Ni-based or Ru-based reformer catalyst.

In the shift converter catalyst layer, the following shift converter reaction occurs:
CO+H₂O→CO₂+H₂ (2)

For the shift converter catalyst layer, for example, Fe—Cr-based, Pt-based, or Cu—Zn-based catalyst may be used. In the selective oxidation catalyst layer, a CO selective oxidation reaction between the shift converter gas and selective oxidation air occurs according to the following equation:
CO+(½)O₂→CO₂ (3)

Oxygen contained in the selective oxidation air oxidizes CO contained in the reformate according to the reaction equation (3) to remove the same. The selective oxidation catalyst may be any one as long as it has a high selective oxidation property to CO, and is, for example, Pt-based, Ru-based, or Pt—Ru-based catalyst. As the hydrocarbon-based fuel, gasses such as methane and city gas, or liquids such as kerosene and gasoline are used.

The fuel supply system/fuel cell cooling system heat exchanger 2 exchanges heat between the reformate flowing through the fuel supply system 3 and the coolant flowing through the fuel cell cooling system 5, to control the dew point of the reformate. The temperature of the reformate at the outlet of the fuel processing system 1 reaches 100 to 120° C., for example. The temperature of the coolant at the inlet of the fuel cell stack 4 needs to be 50 to 60° C., for example. The fuel supply system/fuel cell cooling system heat exchanger 2 may be of either a parallel flow or a counter flow type. As the heat exchanger for use in this embodiment, such ones as a plate type, a coil type, and a fin-tube type are used. The plate type heat exchanger is advantageous in view of the heat transmitting area, so that it can be downsized.

The fuel cell stack 4, also called as cell stack, is to generate electricity using a hydrogen gas contained in the reformate and an oxidizer gas. Details of the fuel cell stack 4 will be described later. The fuel cell cooling system 5 forms a circulation route of the coolant, in which the coolant heated up in the fuel cell stack 4 is cooled with the fuel cell cooling system heat exchanger 6, and is circulated through the fuel cell supply system/fuel cell cooling system heat exchanger 2, to the fuel cell stack 4. The pump 7 is a power source for circulating the coolant in the fuel cell cooling system 5. The fuel cell cooling system heat exchanger 6 is to exchange heat between the coolant flowing through the fuel cell cooling system 5 and the coolant flowing through a coolant piping system 8 provided separately therefrom, and, like the fuel supply system/fuel cell cooling system heat exchanger 2, may be of either the parallel flow or counter flow type.

Flow of the hydrocarbon-based fuel and the coolant in this system configured as described above is described. The hydrocarbon-based fuel is processed in the fuel processing system 1 and reformed into a reformate. The reformate is supplied through the heat exchanger 2 of the fuel cell cooling system to the fuel cell stack 4. On the other hand, the coolant flowing through the fuel cell cooling system 5, after exiting the fuel cell stack 4, is cooled with the coolant piping system 8 in the fuel cell cooling system heat exchanger 6, flows through the heat exchanger 2 for exchanging heat with the fuel supply system 3, and returns to the fuel cell stack 4.

In the fuel cell stack 4, each gas supplied must keep appropriate water content in order to maintain hydrogen ion permeability of a solid polymer membranes 11a. Therefore, the water content in the fuel cell stack 4 is generally controlled, with the fuel supply system/fuel cell cooling system heat exchanger 2, to the extent of saturation at the cell operating temperature. If excess amount of water vapor is small, condensed excess water is carried to respective gas flow passages and taken outside with gasses not used for the cell reaction. However, the configuration is such that, if the excess amount of water vapor exceeds an amount that can be carried with gasses, the gas flow passages are clogged with the condensed water, which causes a phenomenon called flooding and leads to impediment to power generation. Next will be described the details of the configuration of the fuel cell stack 4.

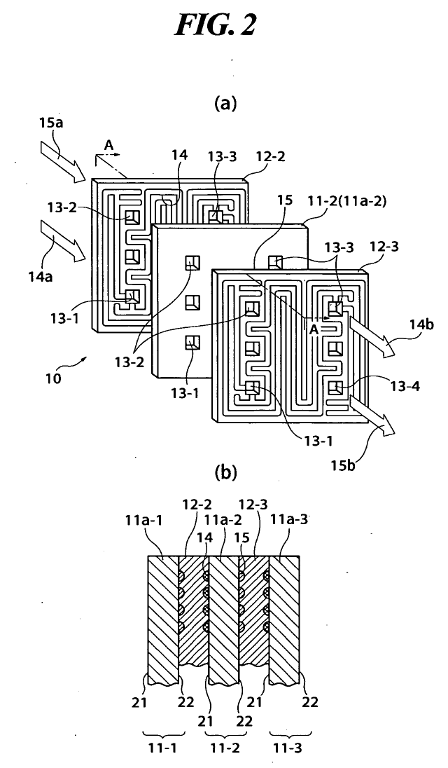

FIG. 2 is a basic structural drawing, illustrating a configuration of the fuel cell stack 4, in which (a) is a perspective view, illustrating a layout of reformate passages and oxidizer gas passages formed in separators, and (b) is a sectional view, illustrating a stacking state of membrane electrode joint members. In FIG. 2(b), the membrane electrode joint members 11-1, 11-2, and 11-3 are formed with solid polymer membranes 11a-1, 11a-2, and 11a-3, each having a fuel electrode (an anode) 21 on one surface and an oxidizer electrode (a cathode) 22 on another. The membrane electrode joint members 11-1, 11-2, and 11-3 are separated with separators 12-2 and 12-3. In the following description, as far as the solid polymer membranes need not be mentioned individually, the symbol for the solid polymer membranes will be mentioned as 11a simply. Likewise, the symbol for the membrane electrode joint member will be mentioned as 11 and that for the separator will be mentioned as 12.

In FIG. 2(a), one surface of the separator 12, which is the surface on the fuel electrode side, is provided with a reformate passage 14, while another surface, which is the surface on the oxidizer electrode side, is provided with an oxidizer gas passage 15, respectively as narrow grooves. The grooves, or both passages, are made to extend uniformly across the entire surfaces on which they are formed. In this way, the solid polymer type fuel cell has a multi-layer structure with the membrane electrode joint members 11 and the separators 12 placed alternately.

When the separator 12 with its surface provided with the groove is placed tightly over the solid polymer membrane 11a, a passage, namely a reformate passage 14, that permits the reformate to pass therethrough, is formed with the groove and the surface of the solid polymer membrane 11a. The same is true for the oxidizer gas passage 15. Here, the fuel electrode 21 and the oxidizer electrode 22 are gas diffusion electrodes, each of which is made by causing a porous conductive material such as a carbon paper to carry a catalyst such as platinum. This electrode is joined to the solid polymer membrane 11a by a method such as hot press to form the membrane electrode joint member 11. The separator 12 is made of a conductive material such as carbon with its both sides provided with the reformate passage 14 and the oxidizer gas passage 15 by cutting, pressing or the like.

The solid polymer membrane 11a in the membrane electrode joint member 11 contains water content to form an electrolyte and selectively permits ionized hydrogen to pass there through. When are formate and an oxidizer gas are supplied to the fuel cell, an electromotive force is produced between the fuel electrode 21 provided on one surface of the membrane 11a and the oxidizer electrode 22 provided on another surface. Furthermore, when the fuel electrode 21 and the oxidizer electrode 22 are connected to an external load, the hydrogen in the reformate is ionized as it releases electrons on the fuel electrode 21. Then the hydrogen ions permeate through the solid polymer membrane 11a, and react on the oxidizer electrode 22 with electrons supplied from the electrode 22 and with Oxygen O₂ in the oxidizer gas to produce water. At the same time, electricity flows through the external load. Incidentally in FIG. 2(a), because only one side of the separator 12 is visible, only the reformate passage 14 is shown. However, the oxidizer gas passage 15 is formed almost likewise on the opposite side of the separator 12.

Because electrons are released from the fuel electrode 21 and absorbed with the oxidizer electrode 22 in the system constituted as described above, a cell is configured in which the fuel electrode 21 serves as the negative pole and the oxidizer electrode 22 as the positive pole. It is also possible to make a multi-layer structure by alternately laminating plural number of the membrane electrode joint members 11 (solid polymer membranes 11a) and the separators 12, and to make the fuel cell of a desired voltage as a whole. In the solid polymer type fuel cell, water is produced at the oxidizer electrode 22, as a result of the electrochemical reaction as described above.

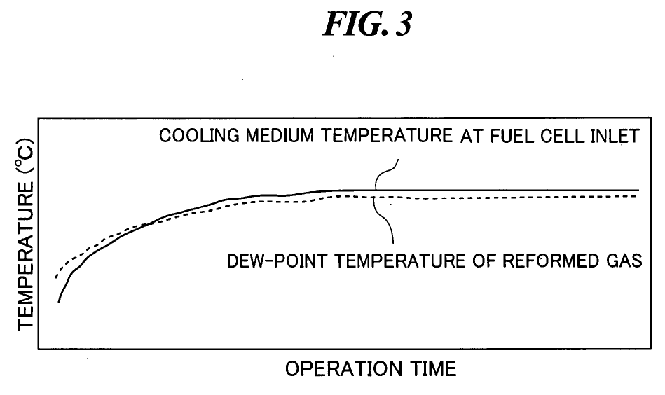

Next will be described the relationship between the dew-point temperature of the reformate and the coolant temperature at the fuel cell inlet in this embodiment. FIG. 3 is a graph, illustrating the changing state of the dew-point temperature of the reformate and the coolant temperature at the fuel cell inlet with the lapse of operation time. Immediately after the fuel cell power generation system starts operation, the dew-point temperature of the reformate is higher than the coolant temperature at the fuel cell inlet. However, after the fuel cell power generation system completes the startup operation and moves on to a steady operation, the heat exchanger 2 works effectively and the dew-point temperature of the reformate becomes lower than the coolant temperature at the inlet of the fuel cell stack 4. It is preferable that the dew-point temperature of the reformate is lower than the coolant temperature at the inlet of the fuel cell stack 4 by about 2to 3° C., so that the cell stack 4 is neither in a too wet state nor in a dry state. In other words, keeping the dew-point temperature of the reformate lower than the internal temperature of the fuel stack 4 by several degrees using the heat exchanger 2 makes it possible to prevent water content in the reformate from condensing within the fuel stack 4 and to generate electricity with the fuel stack 4 in a stabilized manner.

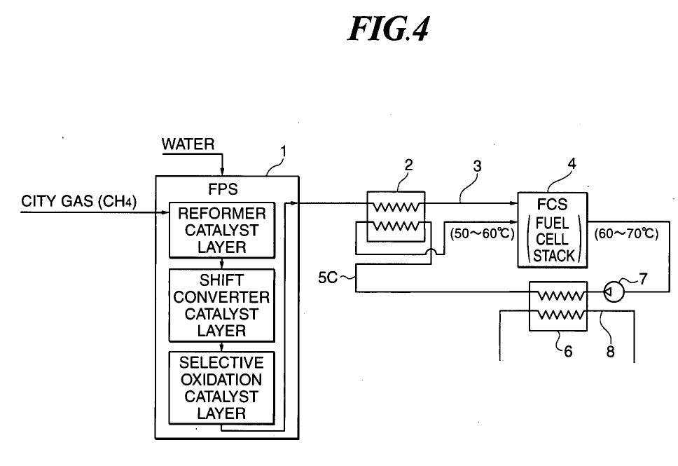

FIG. 4 is a block diagram, illustrating a second embodiment according to the invention. To explain the difference of the embodiment of FIG. 4 from that of FIG. 1, the coolant in the fuel cell cooling system 5C flows in the heat exchanger 2 in the direction counter to the direction of flow of the reformate in the fuel supply system 3. The direction of the flow of the coolant in the fuel cell cooling system 5C may be preferably determined according to whether the heat exchanger 2 is of the parallel flow type or the counter flow type.

Incidentally, while the above embodiments are shown in a configuration of the fuel processing system having reformer catalyst layers, shift converter catalyst layers, and selective oxidation catalyst layers, in effect any arrangement may be used as long as it can reform the hydrocarbon-based fuel into a reformate. Moreover, while the above embodiments are shown with a configuration of the cell stack composed of the solid polymer type fuel cell, the invention is applicable to the other types of fuel cells which require dew point control.

As described above, the fuel cell power generation system according to the invention comprises: the cell stack for generating electricity using the reformate containing hydrogen as a main ingredient thereof and a water content; the fuel processing system for reforming a hydrocarbon-based fuel into the reformate; the first heat exchanger for cooling, with the use of an external coolant, a coolant which cools the cell stack; and the second heat exchanger for exchanging heat between the coolant cooled with the first heat exchanger and the reformate supplied from the fuel processing system to the cell stack, wherein the coolant after exchanging heat with the reformate in the second heat exchanger is supplied to the cell stack. Because the first heat exchanger and the second heat exchanger use the same coolant in common, a single piping suffices for the coolant, resulting in the simplified configuration. Moreover, because the dew point of the reformate supplied from the fuel processing system to the cell stack is controlled with the second heat exchanger, water content in the reformate does not condense within the cell stack.

Reference numerals and symbols of major components used in the above description are enumerated below:
1 fuel processing system (FPS)
2 (fuel supply system/fuel cell cooling system) heat exchanger
3 fuel supply system
4 fuel cell stack (FCS)
5 fuel cell cooling system
6 fuel cell cooling system heat exchanger

What is claimed is:

1. A fuel cell power generation system comprising:
a cell stack for generating electricity using a reformate containing hydrogen as a main ingredient thereof and a water content;
a fuel processing system for reforming a hydrocarbon-based fuel into the reformate;
a first heat exchanger for cooling, with a use of an external coolant, a coolant which cools the cell stack; and
a second heat exchanger for exchanging heat between the coolant cooled with the first heat exchanger and the reformate supplied from the fuel processing system to the cell stack,
wherein the coolant after exchanging heat with the reformate in the second heat exchanger is supplied to the cell stack.

2. The fuel cell power generation system according to claim 1, wherein the second heat exchanger is configured to make a dew-point temperature of the reformate after exchanging heat not higher than a temperature of the coolant after exchanging heat.
